(19) United States
(12) Patent Application Publication
(10) Pub. No.: US 2009/0114091 A1
(43) Pub. Date: May 7, 2009

(54) Apparatus For Producing Water And Dehumidifying Air

(75) Inventor: Dieter Wolfgang Blum, Aldergrove (CA)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(73) Assignee: ALBONIA INNOVATIVE TECHNOLOGIES LTD., Vancouver (CA)

(21) Appl. No.: 12/266,839

(22) Filed: Nov. 7, 2008

Related U.S. Application Data
(60) Provisional application No. 60/986,280, filed on Nov. 7, 2007.

(51) Int. Cl. B03C 3/16; B03C 3/02

(52) U.S. Cl. 95/72; 96/80

(57) ABSTRACT

An apparatus for producing water and dehumidifying air is described. The apparatus causes moisture in an incoming air stream to combine with seed water to remove moisture from the incoming air stream, and may be used to generate water from air, dehumidify air, cool air, and the like. The ability to generate water from air has global importance as the need for clean water increases each year. The apparatus for producing water and dehumidifying air uses high voltage but extremely low current, allowing for both safe and energy efficient operations. The apparatus for producing water and dehumidifying air uses a vessel containing seed water, a bubbler immersed in the seed water, a high voltage source connected to a lower electrode and an upper electrode connected to the negative side of the high voltage source. An airflow path travels through the apparatus and water molecules are extracted from the air as it passes through the apparatus.

### CROSS REFERENCE TO RELATED PATENT APPLICATIONS

This application claims priority to U.S. Patent Application Ser. No. 60/986,280 filed Nov. 7, 2007 entitled “Apparatus For Producing Water And Dehumidifying Air” by Dieter W. Blum of Aldergrove, British Columbia, Canada.

### BACKGROUND OF THE INVENTION

1. Field of the Invention

This invention relates generally to water production and dehumidification, and more particularly to an apparatus for removing water from a source of air.

2. Description of Related Art

In recent years, the need for clean water to satisfy basic human needs has increased tremendously. This is due to increased demand for water as a result of both population growth as well as an increase in contaminants and pollution of water due to human activity and pathogens in water. In addition, fresh water supplies have been further reduced due to global increases in temperature. Also population growth and economic activities have resulted in increased habitation of dry, arid regions of the planet. These regions often times fall short of an adequate supply of drinking water. Thus, there is a critical need for clean sources of drinking water in regions of the world that either lack adequate water or lack clean water. Techniques to remove water from air have been used in the past to dehumidify air for human comfort, condition and cool the air, and improve industrial and commercial processes. Only recently have these water removal processes been looked at to generate drinking water for mankind.

There have been various attempts in the prior art at removing water from air. The most prevalent dehumidification technology uses the condensation of moisture by cooling the air below the saturation temperature by way of the thermodynamic processes of compression and expansion of a coolant. The modern air conditioner, for example, uses this technology. The invention of the air conditioner by Willis Haviland Carrier in upstate New York in 1906 was described in U.S. Pat. No. 808,897 entitled “Apparatus for Treating Air”. The basic Rational Psychrometric Formulae of Willis Haviland Carrier, as disclosed to the American Society of Mechanical Engineers in 1911, formed the basis of all fundamental calculations for the air conditioning industry, and is still in use today. The techniques invented by Carrier are still by far the most common techniques for removing water from air. Unfortunately, these techniques are also energy intensive, creating pollution through the production of electric power required to run the compressors and refrigeration equipment, and also contributing to global climate change. An example of the use of a refrigerant condenser to generate water from air is U.S. Pat. No. 5,149,446 to Reidy, entitled “Potable Water Generator”.

Another technique in the prior art to remove water from air is the adsorption of water molecules by a chemical desiccant material. This process requires a regeneration cycle, which is both energy intensive and mechanically complex.

There exists a third technique to remove water from air. Electrostatic collection of water from air uses the basic premise that a water molecule has a dipole moment, and can also be attracted to a charge. In the presence of a strong electric field, the water molecule will migrate in a predictable direction, and thus be removed from the air. It is noted that the dipole gradient force of the water molecule is relatively weak, but the acquisition of a charge will allow the coulomb force to dominate and react to a strong electric field. Attempts at electrostatic dehumidification technology have used techniques similar to the control of air or liquid flow or the filtering of air using electrostatic principles. Such techniques are disclosed, for example, by Krichtafovitch et al in United States Patent Application Publication US 2006/0226787 A1 entitled “Electrostatic Fluid Accelerator For And Method Of Controlling a Fluid Flow”, the entire disclosure of which is incorporated herein by reference. Many of the electrostatic air dehumidifier projects use corona discharge similar to that used in electrostatic filters for removal of particulate matter from an air stream. Such a project was the Corona Air Pump Project submitted to the American Public Power Association and undertaken by Nels Jewell-Larsen at the University of Washington in Seattle, Wash. Unfortunately, the final report on this project dated Feb. 28, 2005 stated that the investigation was unsuccessful at developing a working electrostatic dehumidification prototype for molecular-water level dehumidification.

It should be noted that the movement of water by a strong electric field has been successfully used in commercial systems such as electrostatic coalescers for the removal of water from raw petroleum. Such techniques go back almost 100 years, and can be seen, for example, in U.S. Pat. No. 1,290,369 to Seibert and Brady entitled “Process of and Apparatus For Treating Oil”. U.S. Pat. No. 987,115 to Cottrell and Speed entitled “Separating and Collecting Particles of One Liquid Suspended in Another Liquid”, issued Mar. 21, 1911 also discloses the use of an electric field to facilitate movement of water. Oil coalescer technology has continued to advance over the years, as is evident by the numerous patents in this field of endeavor.

The use of electrostatics to dehumidify air has been much less explored. There are limited examples of work in this area. One example of such research is contained in a paper entitled “A Novel Dehumidification Technique Using Electric Field” by M. Arif-uz-Zaman et al, published in the IEEE Transactions on Industry Applications, Volume 32, No. 1, January/February 1996. This paper discloses the use of a perforated aluminum plate having a high electric field potential to dehumidify air.

In addition, Professor Stuart Alfred Hoenig has disclosed in U.S. Pat. No. 6,302,944 entitled “Apparatus for Extracting Water Vapor From Air” and in U.S. Pat. No. 4,670,026 entitled “Method and Apparatus For Electrostatic Extraction of Droplets From Gaseous Medium” various techniques for generating high electric fields using arrays of conductive pointed needles to dehumidify air. In addition, United States Patent Application Publication US2001/0029842 A1 to Professor Hoenig entitled “Apparatus Using High Electric Fields to Extract Water Vapor From an Air Flow” discloses an air dryer that uses high voltage direct current to cause moisture to condense out of an airflow in contact with a network of needles having a high intensity electric field within grounded shields. Each of these United States Patents and Published Applications to Professor Hoenig is incorporated herein by reference in their entirety.

There have also been earlier studies into the behavior of water droplets in the presence of an electric field. For example, a manuscript published in the Journal of Applied Meteorology in February 1975 entitled “Charged Droplet Collision Efficiency Measurements” by C. E. Abbott of the National Center For Atmospheric Research, Boulder, Colo., describes the observation of water droplet collisions in the presence of an electric field. Another manuscript published in the Journal of the Atmospheric Sciences in May 1977 entitled “On the Collision Efficiency and the Coalescence of Water Droplets Under the Influence of Electric Forces II: Calculations, Small Reynolds Numbers”, describes collision efficiencies of charged water droplets in an external electrostatic field.

All of these references point to the observed interaction between water and an electrostatic field. The effect of an electrostatic field on water can be simply observed by rubbing a triboelectric material such as polypropylene on wool, fleece, or the like in order to build up an electrostatic charge. The triboelectric material is then placed close to a thin stream of water emanating from, for example, a kitchen faucet. When the electrostatically charged material approaches the thin stream of water, the water stream deflects away from the material due to its inherent electrostatic properties. This fundamental and basic experiment proves that water molecules can be physically directed and moved by an electric field. Unfortunately, the seeming simplicity and widespread nature of water has made the study of it's more fascinating and less understood properties infrequent at best. The study of the more exotic materials in the world today appears more glamorous and is frequently deemed more worthy of attention than the lowly water molecule.

For all of the observed interactions between an electrostatic field and water, and the various attempts to dehumidify air using electrostatics, there has not been success at extracting water from air. In particular, there has not been success at extracting water from air in quantities sufficient for large scale dehumidification and/or water production.

The removal of water molecules from a gaseous stream (ambient air) and subsequent electrostatic condensation of the water molecules has widespread commercial value. Dehumidification of air is one application, but another application that may prove immensely valuable to human civilization is the extraction of clean drinking water from ambient air. Water is essential for all life, and the use of ambient air as an abundant and plentiful source of clean drinking water has unsurpassed benefits to humanity. To convert air to water using very little electrical power makes the apparatus of the present invention all the more beneficial.

It is therefore an object of the present invention to provide an apparatus that removes water from air without the use of energy intensive mechanical cooling. It is another object of the present invention to provide an apparatus that removes water from air without the use of chemical desiccants. It is yet another object of the present invention to provide an apparatus that removes water from air using electrostatic principles but without corona discharge. It is yet another object of the present invention to provide a highly energy efficient apparatus for producing water from air.

### BRIEF SUMMARY OF THE INVENTION

In accordance with the present invention, there is provided an apparatus for producing water and dehumidifying air comprising a vessel containing seed water and having an airflow path through the vessel, a bubbler within the airflow path that is immersed in the seed water, a lower electrode and an upper electrode both of which are electrically connected to a high voltage source.

The foregoing paragraph has been provided by way of introduction, and is not intended to limit the scope of the invention as described by this specification, drawings and claims.

### BRIEF DESCRIPTION OF THE DRAWINGS

The invention will be described by reference to the following drawings, in which like numerals refer to like elements, and in which:

FIG. 1 is a perspective view of the apparatus for producing water and dehumidifying air;

FIG. 2 is a cross sectional view of the apparatus for producing water and dehumidifying air;

FIG. 3 is an upper plan view of the apparatus for producing water and dehumidifying air;

FIG. 4 is a perspective system view of the apparatus for producing water and dehumidifying air;

FIG. 5 is a rotated perspective system view of the apparatus for producing water and dehumidifying air;

FIG. 6 is a perspective view of the electrostatic vessel;

FIG. 7 is a plan view of the upper end cap;

FIG. 8 is a rotated plan view of the vessel;

FIG. 9 is a cross sectional view of the electrostatic vessel;

FIG. 10 is a plan view of the bubbler lower electrode;

FIG. 11 is a perspective view of the bubbler lower electrode;

FIG. 12 is a first embodiment of the upper electrode assembly;

FIG. 13 is a plan view of a first embodiment of the upper electrode assembly;

FIG. 14 is perspective view of a first embodiment of the upper electrode assembly;

FIG. 15 is a plan view of a second embodiment of the upper electrode assembly;

FIG. 16 is a perspective view of a second embodiment of the upper electrode assembly;

FIG. 17 is a plan view of a third embodiment of the upper electrode assembly;

FIG. 18 is a perspective view of a third embodiment of the upper electrode assembly;

FIG. 19 is a plan view of the lower intake assembly;

FIG. 20 is a perspective view of the lower intake assembly; and

FIG. 21 is a detail cross sectional view of the lower vessel assembly.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, drawings, and claims.

### DESCRIPTION OF THE PREFERRED EMBODIMENTS

For a general understanding of the present invention, reference is made to the drawings. In the drawings, like reference numerals have been used throughout to designate identical elements.

To assist with a complete understanding of the present invention, a brief theoretical explanation is warranted. While applicants do not wish to be bound to any particular theory, an understanding of the fundamental interaction of water molecules within the apparatus of the present invention, as viewed by the inventor, may nonetheless be useful for a complete and proper understanding of the present invention and its various embodiments as described and contemplated herein.

Water has a polar bond structure between oxygen and hydrogen that provides for attraction of the water molecules using an electric field. Water is polar in nature. The water molecule forms an angle of 104.45 degrees between the hydrogen atoms with oxygen at the vertex. Since oxygen has a higher electronegativity than hydrogen, the side of the water molecule with the oxygen atom has a partial negative charge, making it a dipole. These charge differences cause water molecules to be attracted to each other and to other polar molecules. The positive areas of one water molecule being attracted to the negative areas of another water molecule, causing combination of water molecules and the eventual formation (or removal) of water. This attraction is known as hydrogen bonding, and helps explain many of the properties of water, and the fundamental principles behind the apparatus of the present invention.

While various attempts have been made in the past to dehumidify air using electric fields, they have met with limited success. It is believed that the mean free path of a water molecule in air before it collides and combines with another water molecule has, in the past, been too great to adequately dehumidify air or generate water. As will be described by way of the drawings, a novel use of electrostatic forces in a vessel where the incoming air is bubbled through a charged polar liquid (such as water) has not been described or attempted in the prior art, and efficiently changes a gaseous state to a liquid state in such a polar liquid. The entrapment of the incoming air within a bubble greatly reduces the mean free path that an entrapped water molecule must travel before combining with another water molecule. Such an apparatus could also be used for cooling through the use of the thermodynamic properties of gas-liquid and liquid-gas state changes. In addition, it is envisioned that the apparatus of the present invention may be used for purification of air in applications such as desalination and the like. It is noted that the use of entrapment of incoming air within a plurality of bubbles to reduce mean free path and improve efficiencies of water molecule combinations has not been disclosed or even suggested in the prior art.

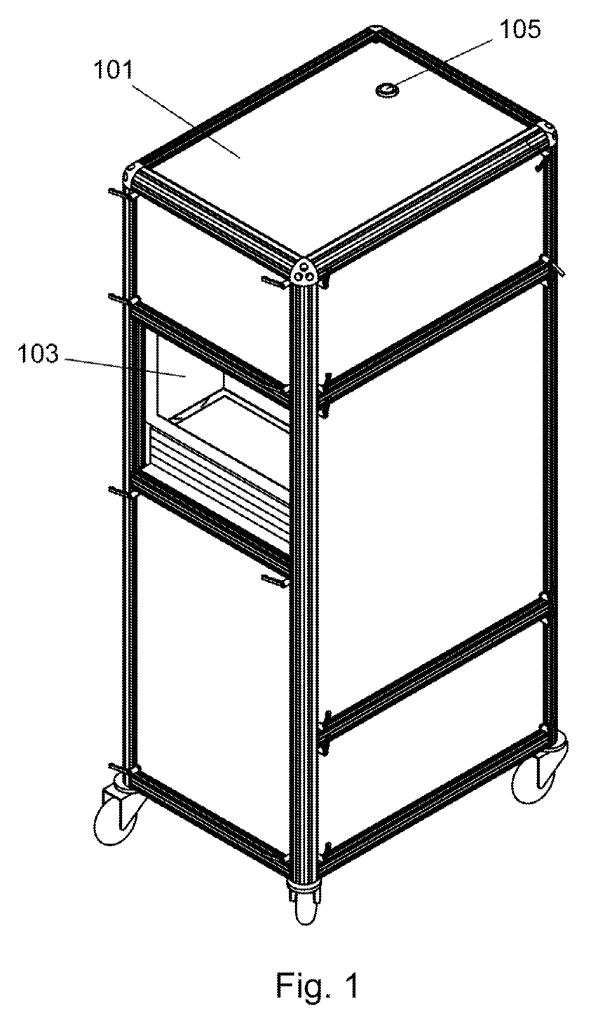

Now turning to the drawings, FIG. 1 shows a perspective view of the apparatus for producing water and dehumidifying air. It should be noted that FIG. 1 portrays the apparatus contained in a cabinet with wheels, however, other embodiments of the present invention may be housed in different structures without departing from the spirit and broad scope of the invention as defined herein. From the exterior of the apparatus as depicted in FIG. 1, one may see the enclosure 101 that may be fabricated from material such as a metal, for example aluminum, a plastic, or the like. The intake 103 of the apparatus may be seen from the exterior of the enclosure 101, as well as the exhaust 105. In operation, the air in proximity to the apparatus is drawn into the intake 103, moved through the various components of the apparatus of the present invention as will be described later in this specification, and then travels to the exhaust 105.

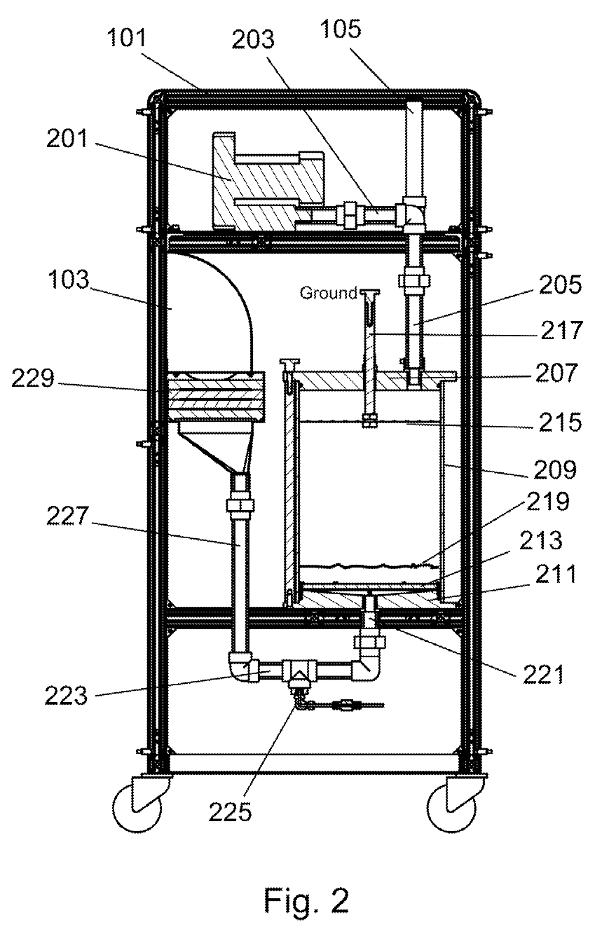

FIG. 2 depicts a cross sectional view of the apparatus for producing water and dehumidifying air. From FIG. 2, one can see many of the components of the apparatus of the present invention. The basic steps to produce water and dehumidify air include drawing air through a vessel 209. The vessel contains a bubbler lower electrode 213 that is energized at a high voltage potential with respect to an upper electrode 215. In other words, the bubbler lower electrode 213 is electrically connected to a positive potential on a high voltage power supply (not shown) and the upper electrode 215 is electrically connected to a negative potential on the high voltage power supply (not shown). In another embodiment of the present invention, the bubbler lower electrode 213 is electrically connected to a negative potential on a high voltage power supply (not shown) and the upper electrode 215 is electrically connected to a positive potential on the high voltage power supply (not shown). The bubbler lower electrode 213 is immersed in a quantity of seed water 219 that has been is placed in the vessel 209 to start the process. The intake air is drawn up through the bubbler lower electrode 213 and produces a plurality of bubbles in the seed water 219. As the intake air becomes entrapped in the plurality of bubbles, the water molecules begin to migrate in the presence of a high voltage electric field that has been applied between the bubbler lower electrode 213 and the upper electrode 215. The migration of the water molecules contained in the entrapped bubbles occurs as the bubbles ascend upward, and many of them migrate into the seed water 219, causing the volume of the seed water to increase. This increased water volume can then be removed as required through any of numerous techniques that are known. The apparatus of the present invention thus produces water that can be used for drinking or other purposes, and also dehumidifies the air that travels through the vessel 209.

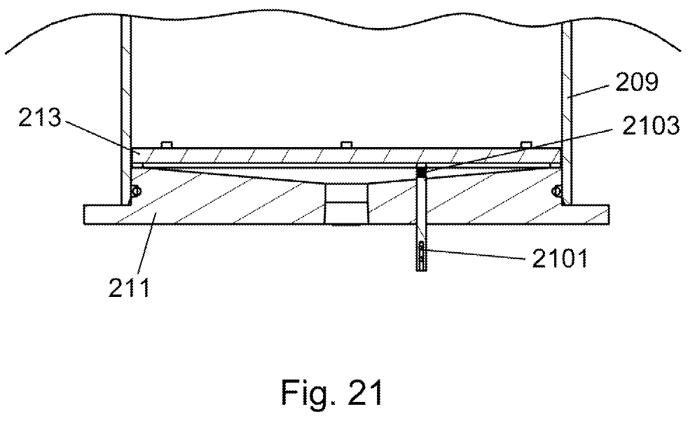

Continuing to refer to FIG. 2, the enclosure 101 can be seen to house the many components of the present invention. Air enters the intake 103 and travels toward the vessel 209. The intake 103 may be made from a metal such as stainless steel, a plastic, or the like. Once passing through the intake 103, the air encounters an intake filter stack 229 that may contain any of several filter types and sizes depending on the specific application in which the apparatus is being used. Once passing through the filter stack 229, the air travels through an intake riser 227 and then through a trap arrangement 223. A bleed off valve 225 or similar arrangement is contained in the trap 223 to purge water that may have traveled downward from the vessel 209. The intake riser 227 and trap 223 may be made from a material such as Polyvinyl Chloride (PVC) piping or the like. The air then continues through a low pressure line 221 that may also be made from Polyvinyl Chloride (PVC) piping or the like. The air then enters the lower end cap 211 of the vessel. The lower end cap 211 may be sealed to the vessel using a gasket, o-ring or the like. The lower end cap 211 may have a funnel shaped or similar recess and mounting apparatus such as bolts for holding the bubbler lower electrode 213. The lower end cap may be made from a material such as metal, a plastic, or the like. The bubbler lower electrode 213 may, in some embodiments of the present invention, be made from a sintered stainless steel or the like. An example of a suitable bubbler lower electrode is the sintered stainless steel discs made by GKN Sinter Metals of Naperville, Ill. The bubbler lower electrode 213 is further connected to a high voltage source such as a high voltage power supply, electrostatic generator such as a Kelvin Dropper, or the like. The high voltage source is not shown in FIG. 1. The high voltage source should be sufficient to generate electrical potentials on the order of 3 kilovolts to 30 kilovolts. The high voltage source may, in some embodiments of the present invention, be direct current (DC). In some embodiments of the present invention, the high voltage source may be direct current positive. In some embodiments of the present invention, the high voltage source may be direct current negative. Some embodiments of the present invention may have a pulsed direct current high voltage source. Other embodiments of the present invention may have a high voltage source with an alternating current component. Some embodiments may further have a high voltage source whose output is modulated. The electrical contacts for the bubbler lower electrode 213 are shown clearly in FIG. 21. In operation, seed water 219 is placed above the bubbler lower electrode 213. As air flows up through the bubbler lower electrode 213 and encounters the seed water 219, bubble streams are generated. As previously described, the interaction of the bubble entrapped air with the seed water 219 causes water to be removed from the entrapped air, and conversely, water to be added to the seed water 219. The upper electrode 215 is a conductive structure that may, in some embodiments of the present invention, be coated with a dielectric material. The upper electrode 215 is mechanically connected to an upper electrode adjustor ground rod 217 that is also made from a conductive material such as stainless steel, copper, brass, or the like. The upper electrode adjustor ground rod 217 passes through the upper end cap 207 and is electrically connected to the ground of the high voltage power supply (not shown for clarity). The upper electrode adjustor ground rod 217 also may be used to adjust the vertical height of the upper electrode 215, allowing for optimal water removal and generation. The upper electrode 215, as will be seen in subsequent drawings, contains holes or passageways to allow the intake air to pass through the upper electrode 215 and up the vacuum line riser 205, through the regenerative blower 201, and out the exhaust 105. As the air travels up through the vessel 209, it encounters an electric field gradient that causes migration of water molecules into a liquid state.

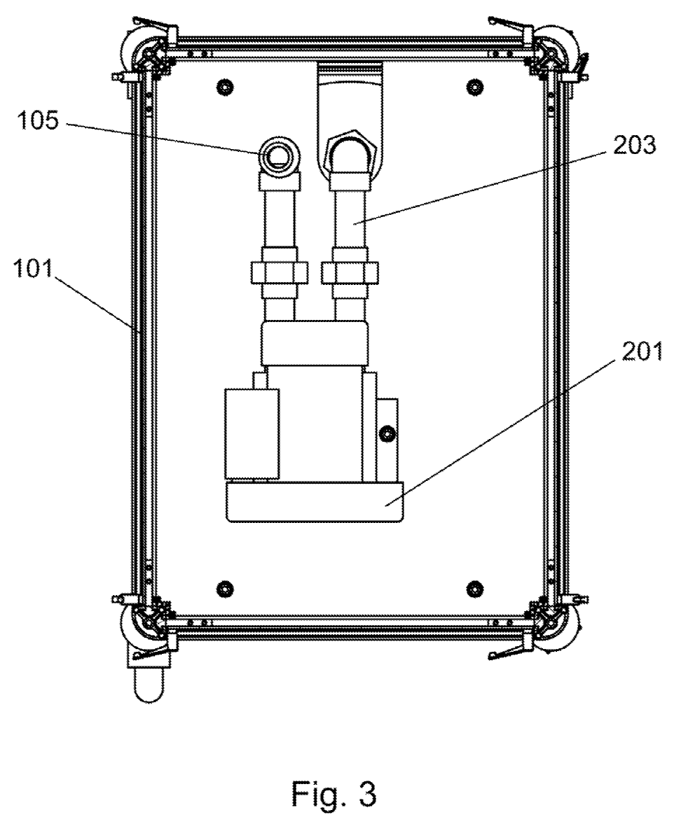

Turning now to FIG. 3, an upper plan view of the apparatus for producing water and dehumidifying air is shown. The vacuum line 203 and the exhaust 105 can be clearly seen as they are connected to the regenerative blower 201. An example of a regenerative blower is the line of regenerative blowers manufactured by The Spencer Turbine Company of Windsor, Conn. A unit such as the model VB-001 or VB-001S that can produce a flow to 25 cubic feet per minute at 1.1 psi would, in one embodiment of the present invention, be suitable. Units that produce various volumes and pressures may also be suitable for other embodiments of the present invention.

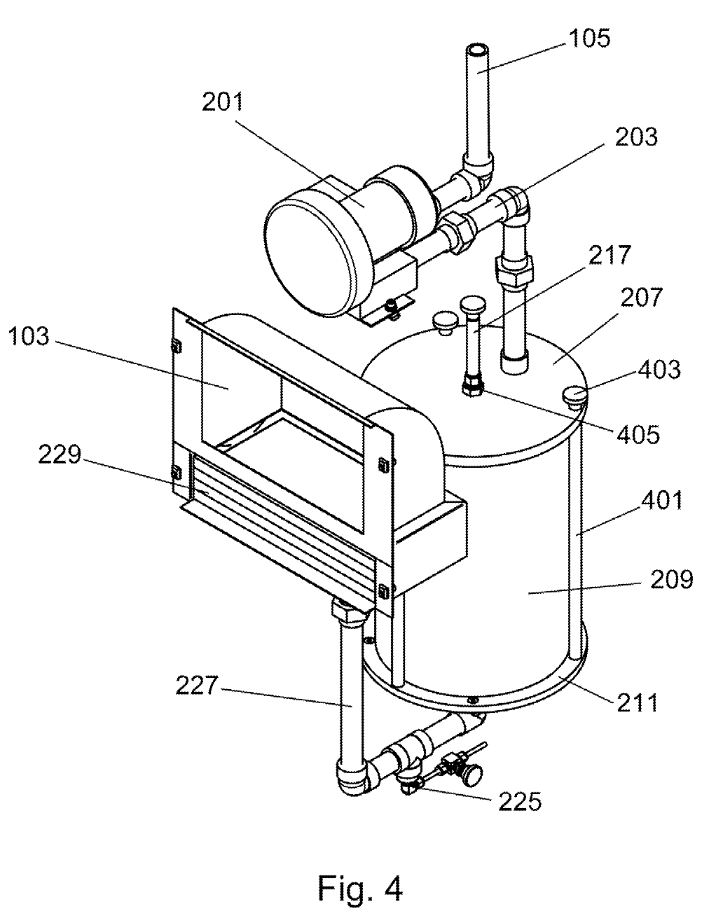

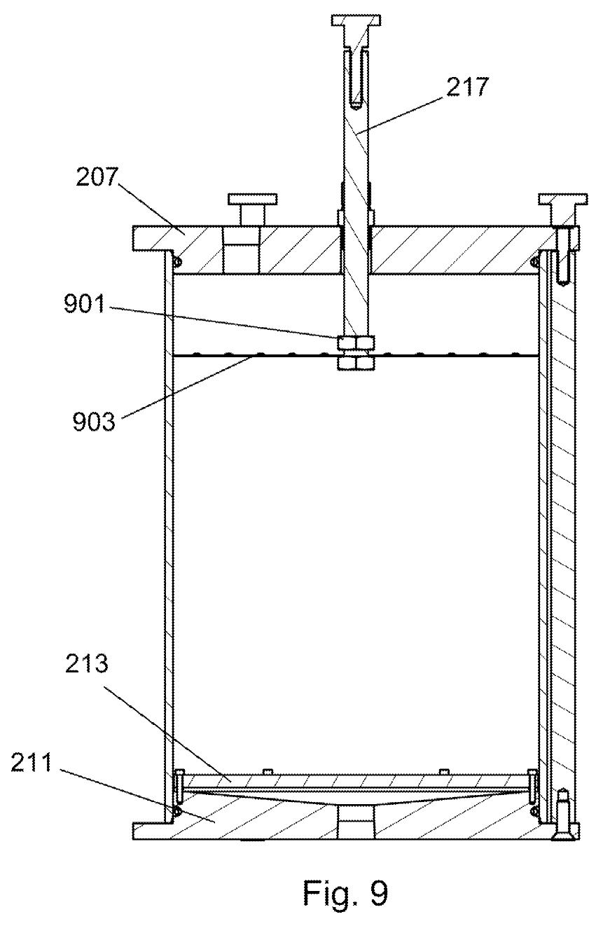

Now turning to FIG. 4 and the perspective system view of the apparatus for producing water and dehumidifying air, one can see the inner workings of the apparatus of the present invention without the visual encumbrance of the exterior enclosure 101. FIG. 4 also allows one to plainly observe that the apparatus for producing water and dehumidifying air may also be mounted in other structures and enclosures, and may also be modified to suit packaging and other physical requirements of any given application of the apparatus. FIG. 4 also shows one technique for assembling and sealing the electrostatic vessel (FIG. 9 to follow also shows a cross sectional view of the electrostatic vessel). It can be observed that the electrostatic vessel has a vessel 209 that may be cylindrical in geometry. An upper end cap 207 and a lower end cap 211 are held to the ends of the vessel 209 by way of a series of tie rods 403. The tie rods 403 may be a metal such as stainless steel with threaded ends and knurled nuts 403 as retainers. Not shown in FIG. 4 are gaskets that are placed between the upper end cap 207 and the lower end cap 211 to provide an airtight and watertight seal. As is good mechanical assembly practice, the tie rod and knurled nut arrangement is uniformly and evenly torque fit to ensure that the gaskets form a proper and adequate seal.

As can also be seen in FIG. 4, the upper electrode adjustor ground rod 217 can be seen protruding through the upper end cap 207. The ground wire termination to the upper electrode adjustor ground rod 217 is not shown for clarity of the drawing. An upper electrode adjustor stay assembly 405 can be seen in FIG. 4. In operation, one may wish to adjust the vertical height of the upper electrode in relation to the bubbler lower electrode for optimization of the water removal process. Once the vertical height has been properly adjusted, the operator may wish to retain that distance, and the upper electrode stay assembly 405 may be used for that purpose. Tightening of the upper electrode stay assembly 405, in a manner similar to that of tightening a nut onto a threaded shaft, will halt vertical movement of the upper electrode adjustor ground rod 217. The upper electrode stay assembly 405 may be made from a metal such as stainless steel, a plastic such as nylon, or the like.

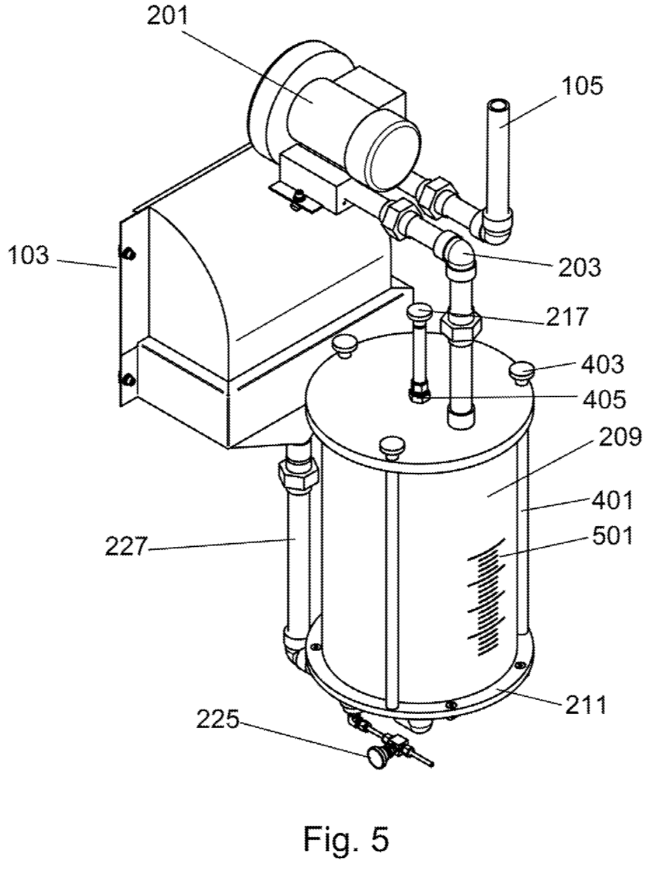

Rotating the perspective system view of FIG. 4, one can see the rotated perspective system view of the apparatus for producing water and dehumidifying air in FIG. 5. The various elements shown in FIG. 4 have been heretofore described in this specification, with the exception of graduated markings 501 that may be inscribed on the vessel 209. Should the vessel 209 be made from an optically transparent material such as polycarbonate, graduated markings 502 may be etched or otherwise inscribed on the vessel 209 to provide an indication of water being produced within the apparatus of the present invention. The graduated markings 502 may be in units of milliliters, liters, ounces, or other suitable units of measure.

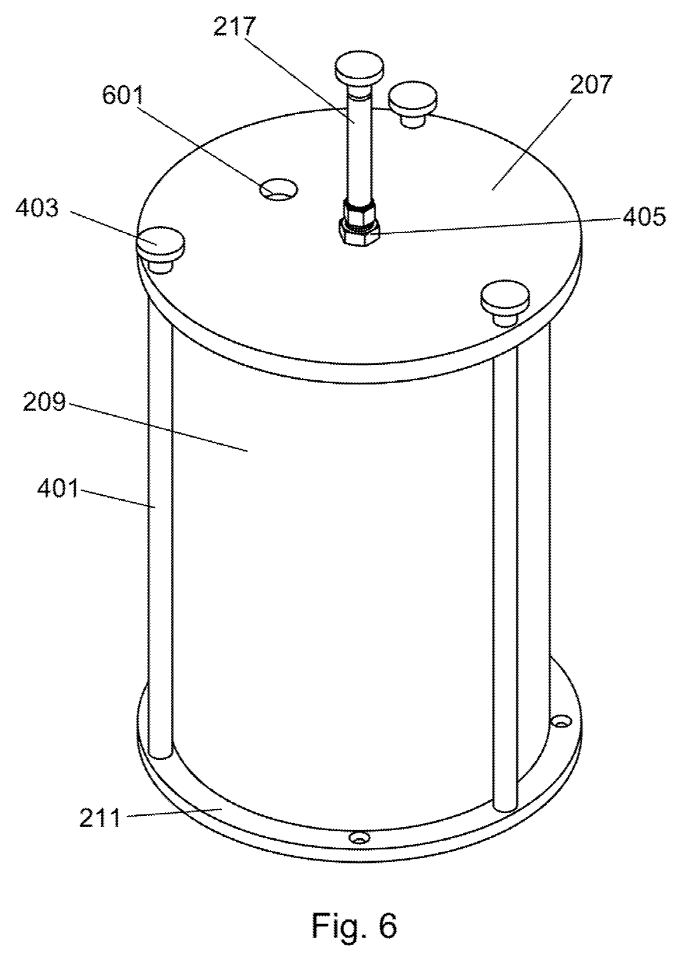

FIG. 6 shows a perspective view of the electrostatic vessel without the air handling elements. An exhaust fitting 601 may be seen passing through the upper end cap 207. The exhaust fitting 601 may be connected to the vacuum line riser 205 (not shown in FIG. 6), or, in an alternative embodiment of the present invention where the air is pushed through the electrostatic vessel (positive air pressure) instead of pulled through the electrostatic vessel (vacuum), the exhaust fitting 601 may be vented to the environment or recirculated back into the electrostatic vessel or delivered through other suitable feedback control mechanisms.

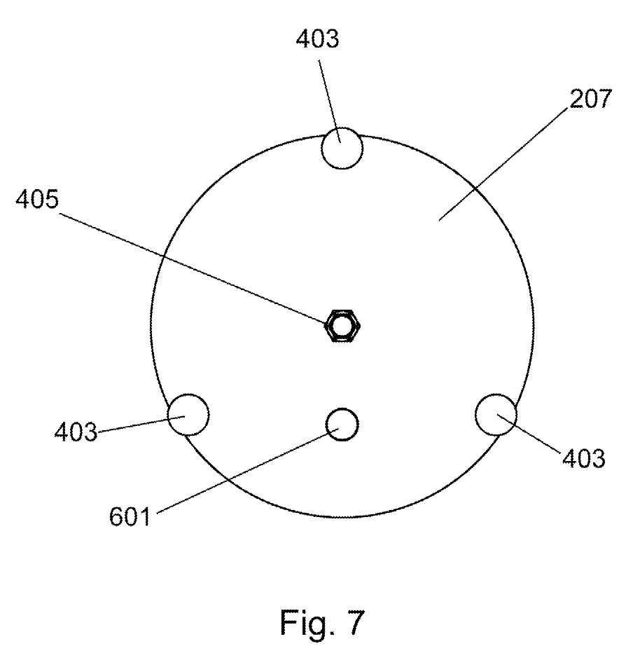

FIG. 7 shows a plan view of the upper end cap 207. The knurled nuts 403 that retain the tie rods are visible, as well as the upper electrode adjustor stay assembly 405 and the exhaust fitting 601. Similar to the vessel 209 and the lower end cap 211, the upper end cap 207 may be made from any suitable material such as stainless steel, copper, brass, polycarbonate, polypropylene, polyvinyl chloride, nylon, or the like.

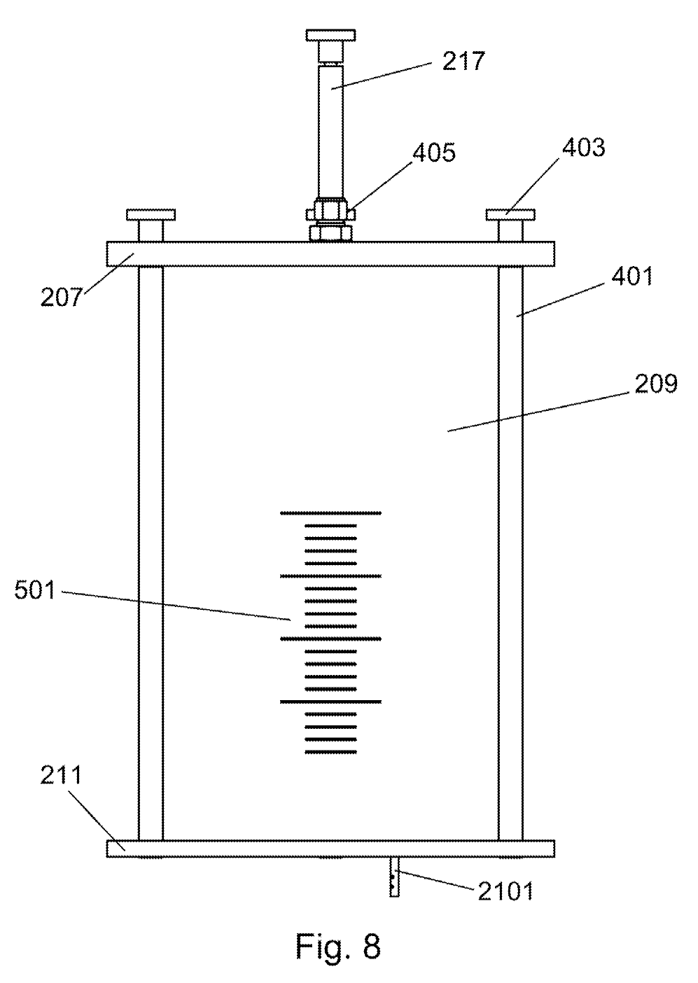

FIG. 8 shows a rotated plan view of the vessel 209. A high voltage contact assembly 2101 is shown passing through the lower end cap 211. The purpose of the high voltage contact assembly 2101 is to provide ohmic contact between the bubbler lower electrode 213 (not seen in FIG. 8) and a high voltage source (not shown). The high voltage contact assembly 2101 is made from a conductive material such as copper, stainless steel or the like. As can be seen in FIG. 8, appropriate physical accommodations such as a hole or holes are provided to accommodate a high voltage conductor leading to a high voltage source.

Turning now to FIG. 9, a cross sectional view of the electrostatic vessel is shown. An upper electrode 903 is shown. As will be known to those skilled in the art, various high voltage electrode arrangements may be used that allow for both the creation of high electric field strength and the passage of air. The upper electrode 903 is connected to the upper electrode adjustor ground rod 217 through the use of an upper electrode fastener such as a nut, threaded insert, compression fitting, or the like. FIG. 9 also provides clarity to the electrostatic vessel components, seals, and fittings.

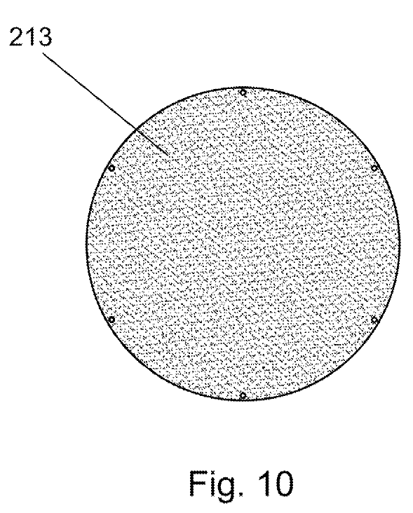

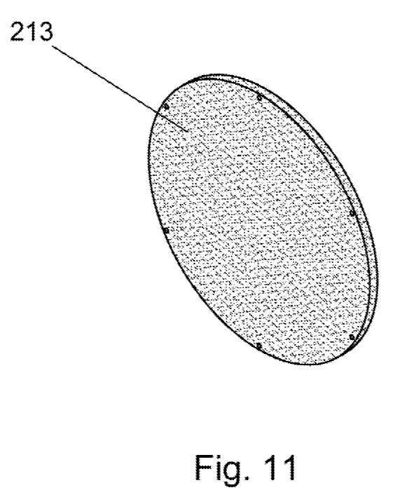

FIG. 10 depicts a plan view of the bubbler lower electrode 213 and FIG. 11 depicts a perspective view of the bubbler lower electrode 213. The bubbler lower electrode 213 may be made from a sintered metal such as sintered stainless steel. Such material may be procured from, for example, GKN Sinter Metals of Naperville, Ill. An appropriate pore size for the material may be selected to provide small and frequent bubbles in the seed water of the apparatus of the present invention. The determination of pore size will be based on the pressure and volume of air and the overall size of the apparatus of the present invention, as well as the specific material selected for the bubbler lower electrode 213. In addition to sintered metals, porous ceramics with conductive materials contained therein, porous ceramics with a conductive layer or coating, or porous ceramics with a discrete lower electrode may also be used. FIGS. 10 and 11 depict six holes in the bubbler lower electrode that may be used to accommodate bolts that will provide downward mechanical force onto a gasket or o-ring to provide an air and water seal between the bubbler lower electrode 213 and the lower end cap 211. More or less holes may be used, or other fastening techniques that are within the grasp of those skilled in the art may also be used.

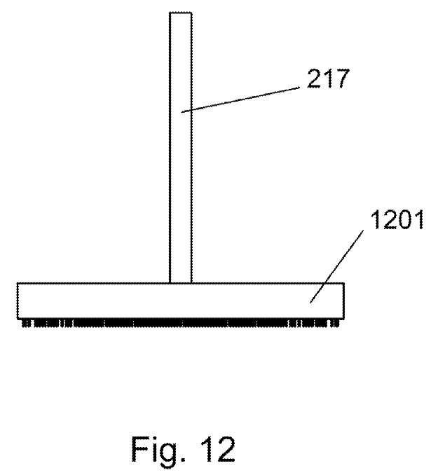

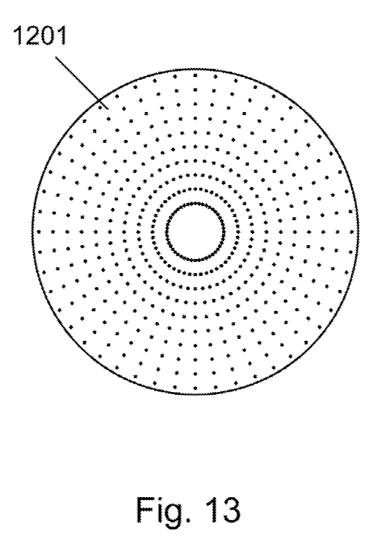

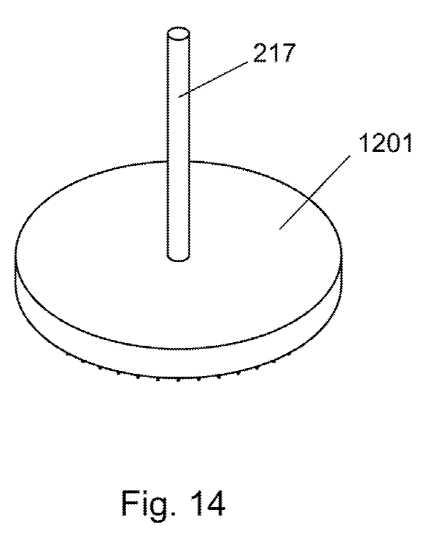

Now turning to FIG. 12, a first embodiment of the upper electrode assembly is shown. This specification depicts several embodiments of the upper electrode assembly. It should be noted that other embodiments not shown in this specification may also be used without departing from the spirit and broad scope of the present invention. FIG. 12 shows a bed of needles electrode 1201. Such an electrode, as is known in the art, creates strong electric field gradient points through its physical geometry. A plurality of conductive needle like points are arranged in a grid-like pattern and electrically interconnected. This plurality of needle like points may then, in some embodiments of the present invention, be encapsulated or otherwise coated in a non-conductive material such as a dielectric. In addition, air passageways between the needle-like points allow air to travel through the bed of needles electrode 1201. FIG. 13 shows a plan view of this first embodiment of the upper electrode. The grid pattern of needle like points is depicted in a concentric ring arrangement; however, other grid patterns may also be used with satisfactory results. FIG. 14 shows a perspective view of this first embodiment of the upper electrode assembly.

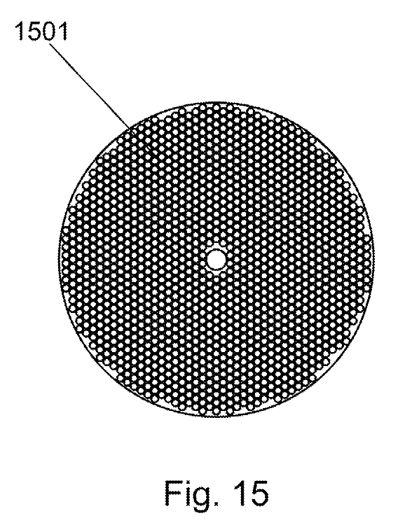

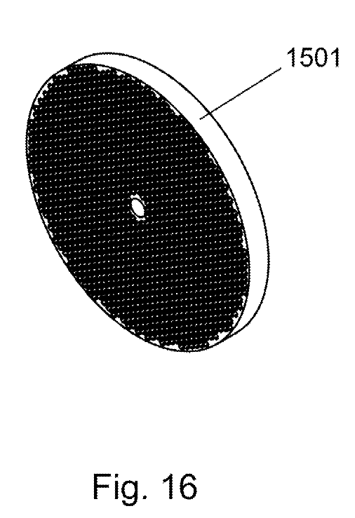

An alternative, or second, embodiment of the upper electrode is depicted in FIG. 15 in plan view. FIG. 15 shows an upper electrode that is made from a honeycomb material such as honeycomb ceramic, aluminum, or the like. FIG. 16 shows a perspective view of this second embodiment of the upper electrode. The honeycomb material may also, in some embodiments of the present invention, be coated with a nonconductive coating such as a dielectric. An example of an aluminum honeycomb material is the aluminum honeycomb manufactured by Alcore of Edgewood, Md. Various pore sizes, wall thicknesses and material thicknesses may be used depending on the specific application of the apparatus of the present invention.

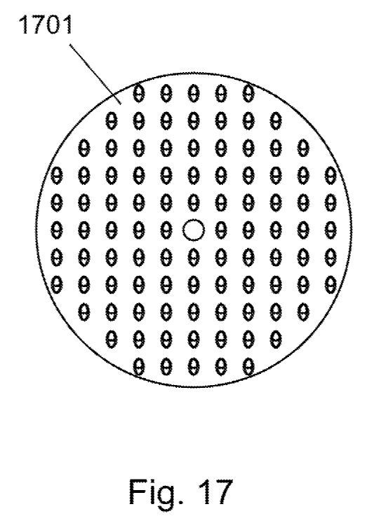

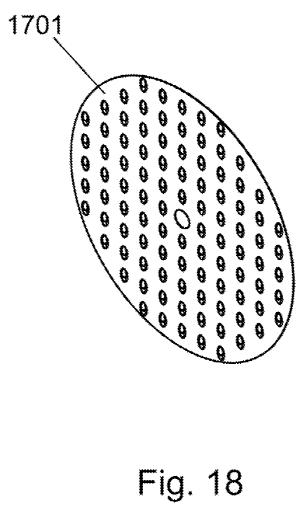

Turning now to FIG. 17, a plan view of yet a third embodiment of the upper electrode is shown. The cheese grater upper electrode 1701 is made from a conductive metal such as stainless steel, and contains a plurality of holes with adjacent depressions or “scoops” similar to the structure of a common cheese grater. The purpose of the holes is to direct airflow through the upper electrode while the depressions serve to further direct the airflow and gather any moisture in the depression. The gathered moisture will then fall by gravity into the seed water where it can be extracted. FIG. 18 shows a perspective view of this third embodiment of the upper electrode, showing clearly the plurality of hole and depression pairs.

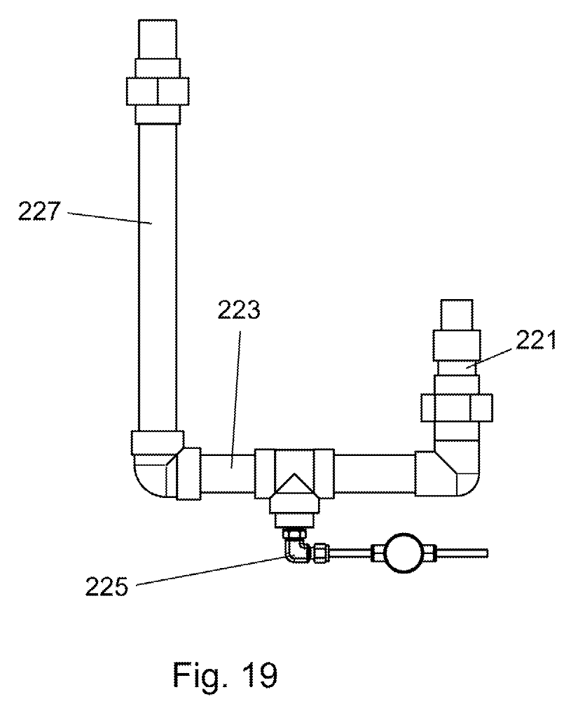

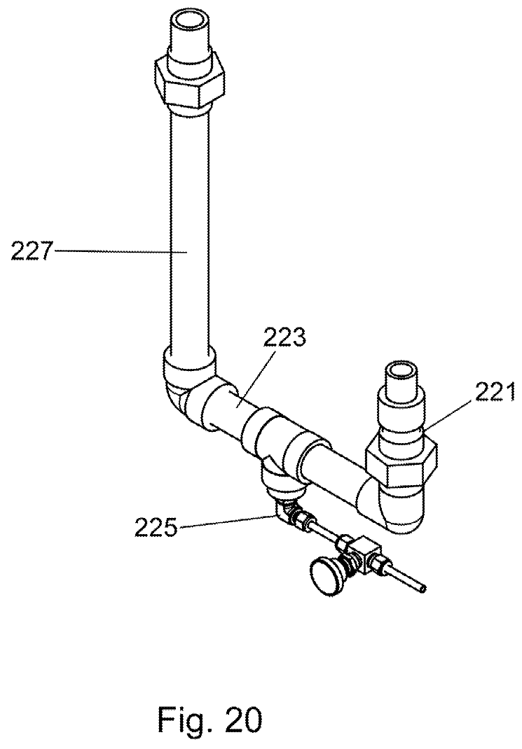

The lower intake assembly can be seen in plan view in FIG. 19. The trap 223 being useful to retain any water that inadvertently makes its way down through the vessel and toward the intake structure. A bleed off valve 225 being present to allow purging of any water retained in the trap 223. FIG. 20 further shows a perspective view of the lower intake assembly.

Lastly, FIG. 21 depicts a detailed cross sectional view of the lower vessel assembly. In the embodiment depicted in FIG. 21, the bubbler lower electrode 213 serves two primary purposes—that of bubble generation and electric field transmission. In serving its latter purpose, proper ohmic contact must be made between the bubbler lower electrode 213 and a suitable high voltage connection to a high voltage source. One way to provide such an ohmic contact is through a high voltage contact assembly 2101 that passes through the lower end cap 211. The high voltage contact assembly 2101 is made of a conductive material such as stainless steel. An ohmic contact 2103 is contained in the high voltage contact assembly 2101 and may, in some embodiments of the present invention, be spring loaded to provide adequate and continued ohmic contact between the high voltage supply (not shown) and the bubbler lower electrode 213.

To operate the apparatus for producing water and dehumidifying air, seed water is placed in the electrostatic vessel and the regenerative blower is turned on. A high voltage source is activated, thus creating an electric field gradient along the path of airflow within the electrostatic vessel. As air flows through the apparatus of the present invention, water molecules in the air become attracted to other water molecules within the apparatus, and are removed from the airflow. Over time, the water level within the vessel increases, and the produced water may be extracted for drinking or other purposes. In addition, the exhaust air will contain reduced humidity, and may be suitable for environmental conditioning and the like.

It is, therefore, apparent that there has been provided, in accordance with the various objects of the present invention, an apparatus for producing water and dehumidifying air. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the present invention as defined by this specification, drawings and claims.

What is claimed is:

1. An apparatus for producing water and dehumidifying air comprising:
a vessel containing seed water;
an airflow path through the vessel;
a bubbler within the airflow path that is immersed in the seed water;
a lower electrode immersed in the seed water;
an upper electrode; and
a high voltage source connected to the lower electrode and the upper electrode.

2. The apparatus for producing water and dehumidifying air as recited in claim 1, further comprising a regenerative blower for creating an airflow through the vessel.

3. The apparatus for producing water and dehumidifying air as recited in claim 1, wherein the airflow path through the vessel is created by way of a vacuum on the surface of the seed water.

4. The apparatus for producing water and dehumidifying air as recited in claim 1, wherein the airflow path through the vessel is created by way of positive air pressure entering the bubbler.

5. The apparatus for producing water and dehumidifying air as recited in claim 1, wherein the distance from the surface of the seed water to the upper electrode is adjustable.

6. The apparatus for producing water and dehumidifying air as recited in claim 1, wherein the upper electrode is a bed of needles.

7. The apparatus for producing water and dehumidifying air as recited in claim 1, wherein the upper electrode is a honeycomb structure.

8. The apparatus for producing water and dehumidifying air as recited in claim 7, wherein the honeycomb structure is aluminum.

9. The apparatus for producing water and dehumidifying air as recited in claim 7, wherein the honeycomb structure is ceramic.

10. The apparatus for producing water and dehumidifying air as recited in claim 1, wherein the upper electrode contains a plurality of holes with adjacent depressions.

11. The apparatus for producing water and dehumidifying air as recited in claim 1, wherein the lower electrode is also a bubbler.

12. The apparatus for producing water and dehumidifying air as recited in claim 1, wherein the lower electrode and the bubbler are made from a sintered metal.

13. The apparatus for producing water and dehumidifying air as recited in claim 1, wherein the lower electrode and the bubbler are made from sintered stainless steel.

14. The apparatus for producing water and dehumidifying air as recited in claim 1, further comprising a spring loaded ohmic contact between the high voltage source and the lower electrode.

15. The apparatus for producing water and dehumidifying air as recited in claim 1, wherein the lower electrode is electrically connected to a positive potential on the high voltage power supply and the upper electrode is electrically connected to a negative potential on the high voltage power supply.

16. The apparatus for producing water and dehumidifying air as recited in claim 1, wherein the lower electrode is electrically connected to a negative potential on the high voltage power supply and the upper electrode is electrically connected to a positive potential on the high voltage power supply.

17. The apparatus for producing water and dehumidifying air as recited in claim 1, wherein the high voltage power supply output is direct current.

18. The apparatus for producing water and dehumidifying air as recited in claim 1, wherein the high voltage power supply output is direct current positive.

19. The apparatus for producing water and dehumidifying air as recited in claim 1, wherein the high voltage power supply output is direct current negative.

20. The apparatus for producing water and dehumidifying air as recited in claim 1, wherein the high voltage power supply is pulsed direct current.

21. The apparatus for producing water and dehumidifying air as recited in claim 1, wherein the high voltage power supply output has an alternating current component.

22. The apparatus for producing water and dehumidifying air as recited in claim 1, wherein the high voltage power supply output is modulated.

23. The apparatus for producing water and dehumidifying air as recited in claim 1, further comprising an air intake.

24. The apparatus for producing water and dehumidifying air as recited in claim 23, further comprising a trap operatively coupled to the air intake.

25. The apparatus for producing water and dehumidifying air as recited in claim 1, wherein the vessel containing seed water is cylindrical.

26. The apparatus for producing water and dehumidifying air as recited in claim 1, further comprising an exhaust fitting.

27. The apparatus for producing water and dehumidifying air as recited in claim 1, wherein the exhaust is recirculated back into the vessel.

28. A method for producing water and dehumidifying air, the method comprising:
creating an airflow path through a vessel containing seed water and air where the airflow path travels through the seed water;
producing a plurality of bubbles in the seed water by way of the airflow path traveling through the seed water; and
applying an electric field gradient between the seed water and the air in the vessel.
